(19) United States
(12) Patent Application Publication
(10) Pub. No.: US 2013/0149572 A1
(43) Pub. Date: Jun. 13, 2013

(54) BATTERY UNIT

(71) Applicants: Yuzo Matsuo, Ibaraki-shi (JP); Ryo Nagai, Ibaraki-shi (JP); Koichi Kajiyama, Ibaraki-shi (JP)

(72) Inventors: Yuzo Matsuo, Ibaraki-shi (JP); Ryo Nagai, Ibaraki-shi (JP); Koichi Kajiyama, Ibaraki-shi (JP)

(73) Assignee: HITACHI MAXELL, LTD., Ibaraki-shi, Osaka (JP)

(21) Appl. No.: 13/818,125

(22) PCT Filed: Jan. 16, 2012
(86) PCT No.: PCT/JP2012/050736

§ 371 Date: Feb. 21, 2013

(30) Foreign Application Priority Data
Jan. 28, 2011 (JP) 2011-016460

(51) Int. Cl. H01M 2/34

(52) U.S. Cl. CPC H01M 2/34
USPC 429/61

(57) ABSTRACT

A battery unit (1) includes battery subunits (11, 12, 13) and a voltage monitoring circuit (30). The battery subunits (11, 12, 13) includes battery modules (110, 120, 130), each having a secondary battery cell (111, 121, 131) and a fuse (112, 122, 132) connected in series. The voltage monitoring circuit (30) monitors the voltage across the terminals of each of the battery subunits (11, 12, 13). Each of the battery subunits (11, 12, 13) includes one battery module or a plurality of battery modules (110, 120, 130) connected in parallel.

### TECHNICAL FIELD

The present invention relates to battery units.

### BACKGROUND ART

JP 2010-67536 A (Patent Document 1) describes a battery pack including a plurality of battery arms in parallel, each battery arm having one or more battery cells and fuses in series, where the voltage at each of the battery cells included in each of the battery arms is measured and, based on this voltage, it is determined whether a fuse has blown (see [0013] and [0016]).

JP 2010-3619 A (Patent Document 2) describes that a control circuit detects a voltage transmitted from the positive electrode of a battery cell and determines whether the detected voltage is within a predetermined range to determine whether the associated battery subunit is abnormal (see [0047] and [0049]).

JP 2004-103483 A (Patent Document 3) describes a plurality of battery subunits in parallel, each battery subunit having secondary battery cells and fuses in series, where the voltage applied to a fuse of a battery subunit is detected and, based on this voltage, it is determined whether the fuse of the battery subunit has blown (see [0013] and [0015]).

JP Hei6 (1994)-223815 A (Patent Document 4) describes a battery assembly including battery groups in series, each battery group having one or more individual batteries connected in parallel via connecting means, where a fuse is connected with an individual battery such that each connecting means has two fuses, one at each of its two terminals, the two fuses having different rated current (see [0009] and FIG. 1).
Patent Document 1: JP 2010-67536 A;
Patent Document 2: JP 2010-3619 A;
Patent Document 3: JP 2004-103483 A; and
Patent Document 4: JP Hei6 (1994)-223815 A.

### DISCLOSURE OF THE INVENTION

The invention of Patent Document 1 monitors the voltage across the two terminals of each of a plurality of secondary battery cells. The invention of Patent Document 2 monitors a voltage transmitted from the positive electrode of a battery cell. The invention of Patent Document 3 monitors the voltage applied to a fuse of a battery subunit. As such, the battery units described in Patent Documents 1 to 3 have complicated circuitry. Patent Document 4 does not describe monitoring a voltage.

In order to prevent deterioration in properties of a battery unit and ensure safety, it is necessary to correctly detect an abnormality in a secondary battery cell. In view of this, conventional battery units are designed to monitor the voltage across the terminals of each secondary battery cell. In other words, the battery units as described above require a large number of voltage monitoring circuits that are connected. Thus, conventional battery units have complicated circuitry.

An object of the present invention is to provide a battery unit having simple circuitry and capable of detecting an abnormality in a secondary battery cell.

A battery unit according to an embodiment of the present invention includes a battery subunit and a voltage monitoring circuit. The battery subunit includes a battery module having a secondary battery cell and a fuse connected in series. The voltage monitoring circuit monitors the voltage across the terminals of the battery subunit. The battery subunit includes one battery module or a plurality of battery modules connected in parallel.

According to an embodiment of the present invention, a plurality of battery subunits may be connected in series. The voltage monitoring circuit may monitor the voltage across the terminals of each of the plurality of battery subunits.

In a battery unit according to an embodiment of the present invention, a battery subunit may include a battery module having a secondary battery cell and a fuse connected in series, and a voltage monitoring circuit may monitor the voltage across the terminals of the battery subunit. If a current equal to or less than the rated current of a fuse is flowing through the fuse, the voltage drop across the fuse is several mV. Thus, monitoring the voltage across the terminals of a battery subunit will make it possible to determine whether the secondary battery cell itself is abnormal. Further, the battery unit according to an embodiment of the present invention is capable of detecting an abnormality in a secondary battery cell as correctly as arrangements that monitor the voltage across the terminals of a secondary battery cell.

Moreover, the voltage monitoring circuit may determine whether the battery subunit is abnormal based on the monitored voltage.

Furthermore, in a battery unit according to an embodiment of the present invention, a voltage monitoring circuit may monitor the voltage across the terminals of a battery subunit having a secondary battery cell and a fuse connected in series. Thus, a battery unit according to an embodiment of the present invention has a smaller number of voltage detectors than arrangements that monitor the terminals of each secondary battery cell, resulting in simpler circuitry.

### BRIEF DESCRIPTION OF THE DRAWINGS

FIG. 1 is a circuit diagram showing the circuit structure of a battery unit according to a first embodiment.

FIG. 2 is an enlarged view of the battery subunit 11 of FIG. 1.

FIG. 3 is a graph showing the current supplied by a secondary battery cell versus the voltage detected by a voltage detector.

FIG. 4 is a flow chart illustrating operations of a first abnormality determination process according to the first embodiment.

FIG. 5 is a flow chart illustrating operations of a first switch control process according to the first embodiment.

FIG. 6 is a circuit diagram showing the circuit structure of a battery unit according to a second embodiment.

FIG. 7 is a flow chart illustrating operations of a second abnormality determination process according to the second embodiment.

FIG. 8 is a flow chart illustrating operations of a second switch control process according to the second embodiment.

FIG. 9 is a circuit diagram showing the circuit structure of a battery unit according to a third embodiment.

FIG. 10 is a flow chart illustrating operations of a third switch control process according to the third embodiment.

### BEST MODES FOR CARRYING OUT THE INVENTION

Embodiments of the present invention will be described in detail with reference to the drawings. Similar or corresponding parts in the drawings are labeled with the same characters, and their description will not be repeated.

### First Embodiment

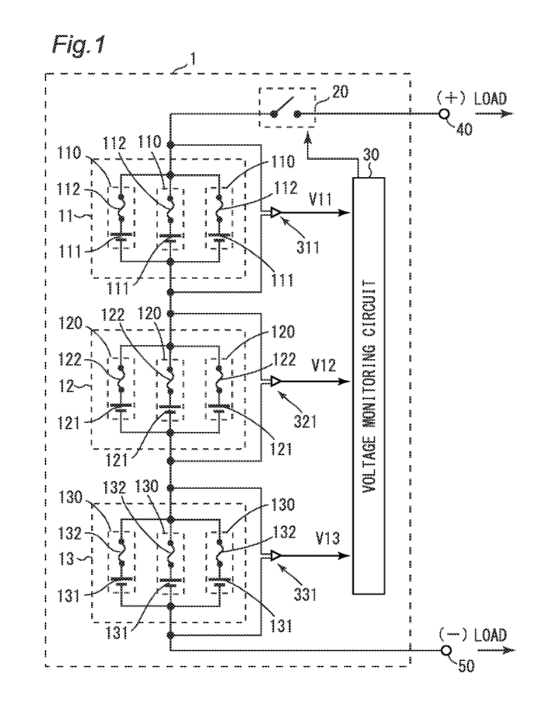

Referring to FIGS. 1 to 5, a battery unit 1 according to a first embodiment will be described. FIG. 1 is a circuit diagram showing the circuit structure of the battery unit 1 of the first embodiment.

The battery unit 1 includes battery subunits 11, 12 and 13, a switch 20, voltage detectors 311, 321 and 331, and a voltage monitoring circuit 30. Identification information ID11, ID12 and ID13 are associated with the battery subunits 11, 12 and 13, respectively. The identification information ID11, ID12 and ID13 are information used to identify the battery subunits 11, 12 and 13, respectively.

The battery subunits 11, 12 and 13 are connected in series between a plus terminal 40 and a minus terminal 50. The battery subunit 11 includes three battery modules 110. The three battery modules 110 are connected in parallel between the switch 20 and the battery subunit 12. Each battery module 110 includes a secondary battery cell 111 and a fuse 112. The secondary battery cell 111 and the fuse 112 are connected in series.

The battery subunit 12 includes three battery modules 120. The three battery modules 120 are connected in parallel between the battery subunit 11 and the battery subunit 13. Each battery module 120 includes a secondary battery cell 121 and a fuse 122. The secondary battery cell 121 and the fuse 122 are connected in series.

The battery subunit 13 includes three battery modules 130. The three battery modules 130 are connected in parallel between the battery subunit 12 and the minus terminal 50. Each battery module 130 includes a secondary battery cell 131 and a fuse 132. The secondary battery cell 131 and the fuse 132 are connected in series.

The secondary battery cells 111, 121 and 131 are chargeable and dischargeable cells and may be, for example, lithium-ion secondary batteries, nickel hydrogen secondary batteries or the like. The fuses 112, 122 and 132 are configured to blow when a current greater than their rated current flows therethrough.

The switch 20 is connected between the positive electrode terminal of the battery subunit 11 and a load. More specifically, it is connected between the positive electrode terminal of the battery subunit 11 and the plus terminal 40. The switch 20 may be formed of a field-effect transistor, for example.

The voltage detector 311 is connected with the two terminals of the battery subunit 11. The voltage detector 321 is connected with the two terminals of the battery subunit 12. The voltage detector 331 is connected with the two terminals of the battery subunit 13.

The voltage detector 311 detects the voltage V11 across the terminals of the battery subunit 11 and outputs the detected voltage V11 to the voltage monitoring circuit 30.

The voltage detector 321 detects the voltage V12 across the terminals of the battery subunit 12 and outputs the detected voltage V12 to the voltage monitoring circuit 30.

The voltage detector 331 detects the voltage V13 across the terminals of the battery subunit 13 and outputs the detected voltage V13 to the voltage monitoring circuit 30.

The voltage monitoring circuit 30 does not monitor the voltage across the terminals of each of the secondary battery cells 111, 121 and 131, but monitors the voltages V11, V12, and V13 across the terminals of the battery subunits 11, 12 and 13. The rated current of the fuses 112, 122 and 132 is larger than the allowable current of the secondary battery cells 111, 121 and 131. When a current equal to or less than the allowable current of the secondary battery cells 111, 121 and 131 (and, consequently, equal to or less than the rated current) flows through the fuses 112, 122 and 132, the voltage drop across the fuses 112, 122 and 132 is several mV. When a current larger than the allowable current and equal to or larger than the rated current flows through the fuses 112, 122 and 132, the resistance of fuses 112, 122, and 132 increases dramatically and the fuses 112, 122, and 132 blow. Thus, as the voltage drop across the fuses 112, 122 and 132 is several mV when the secondary battery cells are normal, the voltage monitoring circuit 30 is capable of monitoring the state of the secondary battery cells 111, 121 and 131 by monitoring the voltages V11, V12 and V13 across the terminals of the battery subunits 11, 12 and 13, respectively.

The voltage monitoring circuit 30 holds a resistance value r, which represents the internal resistance (not shown) of each of the secondary battery cells 111, 121 and 131. The voltage monitoring circuit 30 holds a current value of the allowable current of the secondary battery cells 111, 121 and 131.

The voltage monitoring circuit 30 monitors the voltages V11, V12 and V13 across the terminals of a plurality of battery subunits 11, 12 and 13. More specifically, the voltage monitoring circuit 30 receives the voltages V11, V12 and V13 from the voltage detectors 311, 321 and 331, respectively.

The voltage monitoring circuit 30 determines which one of the battery subunits 11, 12 and 13 is abnormal. More specifically, when it is to be determined whether the battery subunit 11 is abnormal, the voltage monitoring circuit 30 calculates the mean voltage Vave of the voltages V12 and V13 received from the voltage detectors 321 and 331. Then, the voltage monitoring circuit 30 determines whether the battery subunit 11 is abnormal in the manner detailed below. If the voltage monitoring circuit 30 determines that the battery subunit 11 is abnormal, it stores the identification information ID11 of the battery subunit 11.

In an analogous manner, the voltage monitoring circuit 30 determines whether each of the battery subunits 12 and 13 is abnormal.

Then, when the voltage monitoring circuit 30 determines that one of the battery subunits 11, 12 and 13 is abnormal, it further determines whether the switch 20 should be turned off. Specifically, when it is determined that the battery subunit 11 is abnormal, the voltage monitoring circuit 30 calculates the number N of the normal battery modules 110 out of the three battery modules 110 included in the battery subunit 11, in the manner detailed below. The voltage monitoring circuit 30 divides the current flowing through the battery subunit 11 by the calculated number N (i.e. the number of the normal battery modules 110) to calculate the current I1 flowing through one normal secondary battery cell 111. When the current I1 exceeds the allowable current of the secondary battery cells 111 included in the normal battery module 110, the voltage monitoring circuit 30 turns the switch 20 off. Thus, the battery unit 1 stops the supply of power to the load.

In an analogous manner, the voltage monitoring circuit 30 determines whether the switch 20 should be turned off when it is determined that the battery subunit 12 or 13 is abnormal.

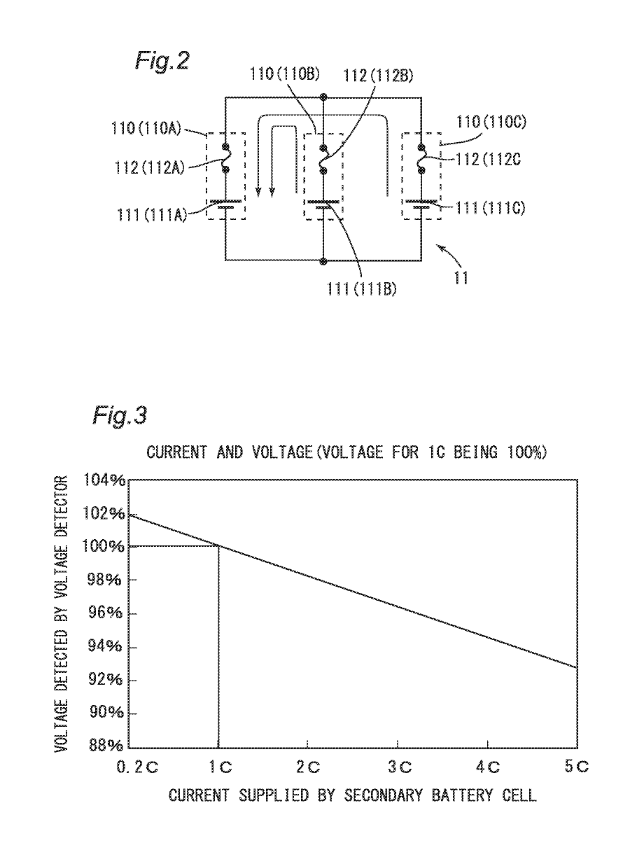

Next, when one of the secondary battery cells 111, 121 and 131 is abnormal, how to blow one of the fuses 112, 122 and 132 connected in series to the secondary battery cells 111, 121 and 131 will be described. FIG. 2 is an enlarged view of the battery subunit 11 of FIG. 1.

When the secondary battery cell 111A is abnormal, an overcurrent flows into the secondary battery cell 111A from the normal secondary battery cells 111B and 111C. When this overcurrent flows through the fuse 112A, a current larger than the rated current of the fuse 112A flows therethrough, therefore the fuse 112A blows.

When one of the secondary battery cells 111B and 111C is abnormal, the fuse connected in series to the abnormal secondary battery cell blows in an analogous manner. When one of the secondary battery cells 121 and 131 in one of the battery subunits 12 and 13 is abnormal, the fuse connected in series to the abnormal secondary battery cell blows in an analogous manner.

FIG. 3 is a graph showing the current supplied by a secondary battery cell 111 versus the voltage V11 detected by the voltage detector 311. As the current supplied by one secondary battery cell 111 increases, the voltage V11 across the terminals of the battery subunit 11 decreases. This means that, as the number of the abnormal battery modules 110 in the battery subunit 11 increases, the voltage V11 across the terminals of the voltage subunit 11 decreases. Thus, the voltage monitoring circuit 30 is capable of determining whether the battery subunit 11 is abnormal by monitoring the voltage V11 across the terminals of the battery subunit 11.

In view of the above, the first embodiment determines whether the battery subunit 11 is abnormal in the following manner.

The voltage monitoring circuit 30 determines that the battery subunit 11 is abnormal when the difference between the mean voltage Vave of the voltages V12 and V13 across the terminals of the battery subunits 12 and 13, which are not being examined for an abnormality, and the voltage V11 across the terminals of the battery subunit 11, which is being examined for an abnormality, is equal to or larger than a threshold. In the present implementation, the threshold is preset to rI/6. The reasons why the threshold is preset to rI/6 will be described below.

When all the battery modules 110 in the battery subunits 11 are normal, the combined internal resistance of the three secondary battery cells 111 in the battery subunit 11 is r/3. When the current I flows through the battery subunit 11, the internal resistance causes the voltage to decrease by rI/3. Thus, if the output voltage of the secondary battery cells 111 is V0, the voltage detector 311 detects the voltage V11A (=V0−rI/3). If all the battery modules 110 in the battery subunit 11 are normal, the voltage monitoring circuit 30 receives the voltage V11A (=V0−rI/3) from the voltage detector 311.

When two of the three battery modules 110 in the battery subunit 11 are normal (i.e. one battery module 110 is abnormal), the combined internal resistance of two secondary battery cells 111 in the battery subunit 11 is r/2. When the current I flows through the battery subunit 11, the internal resistance causes the voltage to decrease by rI/2. Thus, the voltage detector 311 detects the voltage V11B (=V0−rI/2). That is, if one battery module 110 in the battery subunit 11 is abnormal, the voltage monitoring circuit 30 receives the voltage V11B (=V0−rI/2) from the voltage detector 311.

When one of the three battery modules 110 in the battery subunit 11 is normal (i.e. two battery modules 110 are abnormal), the combined internal resistance of secondary battery cell 111 in the battery subunit 11 is r. When the current I flows through the battery subunit 11, the internal resistance causes the voltage to decrease by rI. Thus, the voltage detector 311 detects the voltage V11C (=V0−rI). That is, when two battery modules 110 in the battery subunit 11 are abnormal, the voltage monitoring circuit 30 receives the voltage V11C (=V0−rI) from the voltage detector 311.

Thus, depending on the number of the normal battery modules 110 in the battery subunit 11, the voltage monitoring circuit 30 receives the voltages V11A to V11C with different values. The difference between the voltage V11A across the terminals of the battery subunit 11 that all the battery modules 110 are normal and the voltage V11B across the terminals of the battery subunit 11 that there is an abnormality in one battery module 110 is rI/6 (=(V0−rI/3)−(V0−rI/2)). The difference between the voltage V11A and the voltage V11C across the terminals of the battery subunit 11 that there are an abnormality in two battery modules 110 is 2rI/3 (=V0−rI/3)−(V0−rI)).

In the present embodiment, if the difference between the mean voltage Vave and the voltage V11 across the terminals of the battery subunit 11 which is being examined for an abnormality is rI/6 (=V0−rI/3)−(V0−rI/2)), the voltage monitoring circuit 30 determines that one battery module 110 is abnormal. If the difference between the mean voltage Vave and the voltage V11 across the terminals of the battery subunit 11, Vave−V11, is 2rI/3 (=V0−rI/3)−(V0−rI)), the voltage monitoring circuit 30 determines that two battery modules 110 are abnormal.

That is, the voltage monitoring circuit 30 determines that there is an abnormality in one or more battery module 110 when the difference between the mean voltage Vave and the voltage V11 across the terminals of the voltage subunit 11 which is being examined for an abnormality is rI/6 or larger. Thus, the voltage monitoring circuit 30 is capable of determining whether the battery subunit 11 is abnormal by monitoring the voltage V11 across the terminals of the battery subunit 11.

When all the battery modules 110 in the battery subunit 11 are abnormal, the voltage monitoring circuit 30 receives the voltage V11 (=−(V12+V13)) from the voltage detector 311. In this case, the voltage monitoring circuit 30 determines that the battery subunit 11 is abnormal.

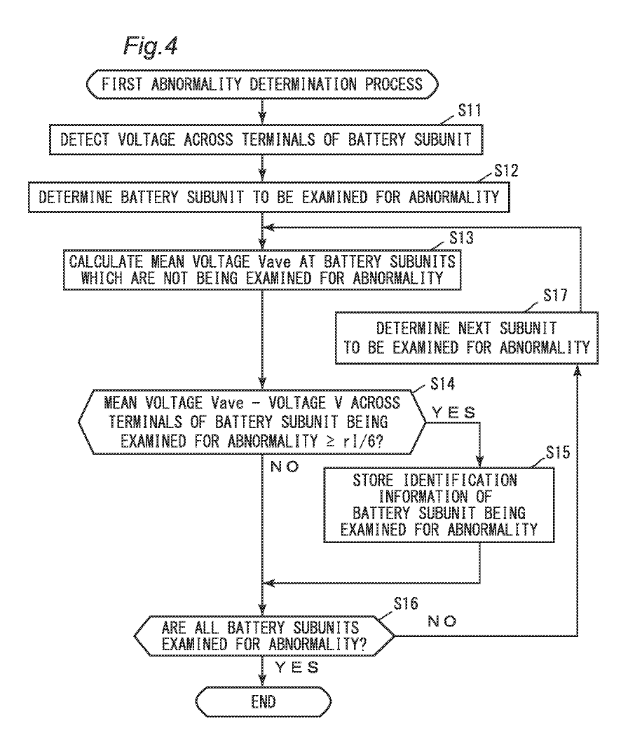

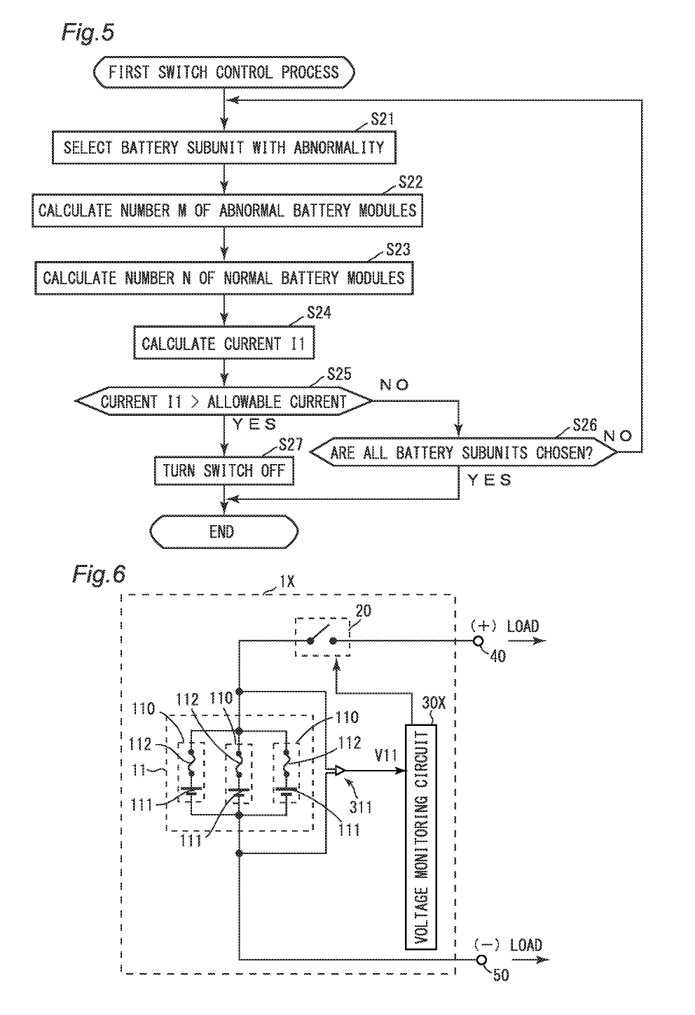

Next, referring to FIGS. 4 and 5, operations of the battery unit 1 in the first embodiment will be described. Operations of the battery unit 1 in the first embodiment include a first abnormality determination process shown in FIG. 4, and a first switch control process shown in FIG. 5. First, the first abnormality determination process will be described with reference to FIG. 4. The first abnormality determination process is performed at regular time intervals.

Upon starting the first abnormality determination process, the voltages V11, V12 and V13 across the terminals of the battery subunits 11, 12 and 13 are detected (step S11). Specifically, the voltage detectors 311, 321 and 331 detect the voltages V11, V12 and V13 across the terminals of the battery subunits 11, 12 and 13, respectively, and output the detected voltages V11, V12 and V13 to the voltage monitoring circuit 30.

After step S11, a battery subunit to be examined for an abnormality is determined (step S12). Specifically, the voltage monitoring circuit 30 chooses any one battery subunit out of the battery subunits 11, 12 and 13 to be examined for an abnormality. For example, the voltage monitoring circuit 30 chooses the battery subunit 11 as the battery subunit to be examined for an abnormality.

After step S12, the mean voltage Vave of the battery subunits which are not being examined for an abnormality is calculated (step S13). Specifically, the voltage monitoring circuit 30 calculates the mean voltage Vave by calculating the mean value of the voltages V12 and V13 across the terminals of the battery subunits 12 and 13 which are not examined for an abnormality at step S12.

After step S13, the voltage monitoring circuit 30 determines whether the difference between the mean voltage Vave and the voltage V11 across the terminals of the battery subunit 11 which is being examined for an abnormality is rI/6 or larger (step S14). Thus, the voltage monitoring circuit 30 is capable of determining whether the battery subunit 11 is abnormal.

If the difference between the mean voltage Vave and the voltage V11 is rI/6 or larger (YES at step S14), the voltage monitoring circuit 30 determines that the battery subunit 11 is abnormal, and stores the identification information ID11 of the battery subunit 11 which is being examined for an abnormality (step S15). Then, the process advances to step S16.

If the difference between the mean voltage Vave and the voltage V11 is smaller than rI/6 (NO at step S14), it is determined that the battery subunit 11 is normal and the process advances to step S16.

After step S15, or if NO at step S14, it is determined whether all the battery subunits 11, 12 and 13 have been examined by the first abnormality determination (step S16).

If it is determined that all the battery subunits 11, 12 and 13 have not been examined by the first abnormality determination (NO at step S16), the voltage monitoring circuit 30 determines a next subunit to be examined (step S17). Specifically, the voltage monitoring circuit 30 determines a next subunit to be examined by choosing any one of battery subunit out of the battery subunits other than the one(s) that has/have already been examined for an abnormality.

Thereafter, the process returns to step S13, and steps S13 to S17, described above, are repeated until it is determined that all the battery subunits 11, 12 and 13 have been examined by the first abnormality determination at step S16.

If it is determined that all the battery subunits 11, 12 and 13 have been examined by the first abnormality determination at step S16 (YES at step S16), the first abnormality determination process ends.

By performing the first abnormality determination process described above, the voltage monitoring circuit 30 is capable of determining whether the battery subunits 11, 12 and 13 are abnormal based on the voltages V11, V12 and V13 across the terminals of the battery subunits 11, 12 and 13.

Next, the first switch control process will be described with reference to FIG. 5. The first switch control process is performed on a regular basis when the voltage monitoring circuit 30 holds identification information.

First, the battery subunit for which it has been determined that there is an abnormality is chosen (step S21). Specifically, the voltage monitoring circuit 30 chooses the battery subunit corresponding to the identification information stored at step S15. In the present implementation, it is assumed that the battery subunit 11 is chosen.

After step S21, the number M of the battery modules 110 with abnormalities in the chosen battery subunit 11 is calculated (step S22). Specifically, the voltage monitoring circuit 30 calculates the difference Vave−V11 between the mean voltage Vave and the voltage V11 across the terminals of the battery subunit 11 chosen at step S21. Then, the voltage monitoring circuit 30 calculates the number M of the battery modules 110 with abnormalities based on the difference Vave−V11 between the mean voltage Vave and the voltage V11 across the terminals of the battery subunit 11.

As discussed above, if the difference Vave−V11 between the mean voltage Vave and the voltage V11 is rI/6 (=(V0−rI/3)−(V0−rI/2)), the voltage monitoring circuit 30 sets the number M of the battery modules 110 with abnormalities to 1. If the difference Vave−V11 between the mean voltage Vave and the voltage V11 across the terminals of the battery subunit 11 with an abnormality is 2rI/3 (=V0−rI/3)−(V0−rI)), the voltage monitoring circuit 30 sets the number M of the battery modules 110 with abnormalities to 2.

After step S22, the number N of the normal battery modules 110 out of the battery modules 110 included in the battery subunit 11 is determined (step S23). Specifically, the voltage monitoring circuit 30 calculates the number N of the normal battery modules 110 out of the battery modules 110 included in the battery subunit 11 by calculating the difference between the entire number of the battery modules 110 included in the battery subunit 11 and the number M calculated at step S22.

After step S23, the current I1 is calculated (step S24). Specifically, the voltage monitoring circuit 30 calculates the current I1 flowing through one normal battery module 110 by dividing the current flowing through the battery subunit 11 by the number N of the normal battery modules 110.

After step S24, the voltage monitoring circuit 30 determines whether the current I1 exceeds the allowable current of the secondary battery cell 111 (step S25).

If the current I1 does not exceed the allowable current of the secondary battery cell 111 (NO at step S25), it is determined whether all the battery subunits whose identification information is stored have been chosen (step S26).

If all the battery subunits whose identification information is stored have not been chosen (NO at step S26), the process returns to step S21, and a battery subunit for which it has been determined that there is an abnormality is chosen. Specifically, the voltage monitoring circuit 30 chooses a battery subunit that has not been chosen yet out of all the battery subunits whose identification information is stored.

If all the battery subunits whose identification information is stored have been chosen (YES at step S26), the first switch control process ends, with the switch 20 remaining on.

If the current I1 exceeds the allowable current of the secondary battery cell 111 (YES at step S25), the voltage monitoring circuit 30 turns the switch 20 off (step S26). Thus, the battery unit 1 stops the power supply to the load. Upon performing step S26, the first switch control process ends.

Although not discussed in the above description, the voltage monitoring circuit 30 turns the switch 20 off if it determines that all the battery modules 110 in the battery subunit 11 are abnormal (i.e. the voltage monitoring circuit 30 receives the voltage V11 (=−(V12+V13)) from the voltage detector 311).

By performing the first switch control process described above, the battery monitoring circuit 30 does not turn the switch 20 off even if the battery subunit 11 is abnormal as long as the current flowing through the secondary battery cell 111 is equal to or less than its allowable current. That is, the battery unit 1 is capable of continuing to supply power to the load.

### Effects of the First Embodiment

In the battery unit 1 according to the first embodiment, the battery subunits 11, 12 and 13 include the battery modules 110, 120 and 130 in which the secondary battery cells 111, 121 and 131 are connected in series to fuses 112, 122 and 132, and a voltage monitoring circuit 30 monitors the voltages V11, V12 and V13 across the terminals of the battery subunits 11, 12 and 13. If a current equal to or less than the rated current of the fuses 112, 122 and 132 flows therethrough, the voltage drop across the fuses 112, 122 and 132 is several mV. Thus, it may be determined whether the secondary battery cells 111, 121 and 131 are abnormal by monitoring the voltages V11, V12 and V13 across the terminals of the battery subunits 11, 12 and 13. Further, the battery unit 1 of the first embodiment is capable of detecting an abnormality in the secondary battery cells 111, 121 and 131 with a similar precision to that for monitoring the voltages across the terminals of the secondary battery cells 111, 121 and 131.

Further, the voltage monitoring circuit 30 is capable of determining whether the battery subunits 11, 12 and 13 are abnormal based on the voltages V11, V12 and V13 that it monitors.

Further, in the battery unit 1 according to the first embodiment, the voltage monitoring circuit 30 monitors the voltages V11, V12 and V13 across the terminals of the battery subunits 11, 12 and 13 in which the secondary battery cells 111, 121 and 131 are connected in series to the fuses 112, 122 and 132. Thus, the battery unit 1 according to the first embodiment has a reduced number of the voltage detectors compared with implementations where the voltages across the terminals of the secondary battery cells 111, 121 and 131 are monitored, resulting in simplified circuitry.

### Variations of the First Embodiment

In the first embodiment, each of the battery modules 110, 120 and 130 includes one secondary battery cell 111, 121 or 131, however, the embodiment is not limited to such a configuration. For example, each of the battery modules 110, 120 and 130 may include a plurality of secondary battery cells 111, 121 or 131 connected in series.

In the first embodiment, the battery subunits 11, 12 and 13 include the same number of battery modules 110, 120 or 130, respectively, however, the embodiment is not limited to such a configuration. For example, battery subunits may have a different number of battery modules.

In the first embodiment, it is determined, at step S14, whether the difference between the mean voltage Vave and the voltage at a battery subunit which is being examined for an abnormality is rI/6 or larger, however, the embodiment is not limited to such a configuration. For example, the voltage monitoring circuit 30 may hold an empirically determined voltage across the terminals of the battery subunits 11, 12 and 13 experienced when the battery subunits 11, 12 and 13 are normal, and use this voltage across the terminals of the battery subunits 11, 12 and 13 experienced when the battery subunits 11, 12 and 13 are normal, instead of the mean voltage Vave of step S14.

In the above description, the switch 20 is connected between the positive electrode terminal of the battery subunit 11 and the load, however, the embodiment is not limited to such a configuration. The switch 20 may be connected between the negative electrode terminal of the battery subunit 13 and the load.

### Second Embodiment

Next, referring to FIGS. 6 to 8, a battery unit 1X according to a second embodiment will be described. FIG. 6 is a circuit diagram showing the circuit structure of the battery unit 1X according to the second embodiment.

The battery unit 1X according to the second embodiment is similar to the battery unit 1 except for replacing the voltage monitoring circuit 30 of the battery unit 1 shown in FIG. 1 by a voltage monitoring circuit 30X and eliminating the battery subunits 12 and 13 and voltage detectors 321 and 331. That is, while the battery unit 1 of the first embodiment includes the battery subunits 11, 12 and 13, the battery unit 1X of the second embodiment includes the battery subunit 11.

The voltage monitoring circuit 30X holds an empirically determined voltage VX across the terminals of the battery subunit 11 experienced when the battery subunit 11 is normal. Otherwise, the voltage monitoring circuit 30X is similar to the voltage monitoring circuit 30 of the first embodiment.

The voltage monitoring circuit 30X monitors the voltage V11 across the terminals of the battery subunit 11. Specifically, the voltage monitoring circuit 30X receives the voltage V11 from the voltage detector 311.

Then, the voltage monitoring circuit 30X determines whether the battery subunit 11 is abnormal in the manner detailed below. If the voltage monitoring circuit 30X determines that the battery subunit 11 is abnormal, it further determines whether to turn the switch 20 off. Specifically, operations similar to those in steps S22 to S23 of FIG. 5 are performed to calculate the number N of the normal battery modules 110 out of the three battery modules 110 included in the battery subunit 11. The voltage monitoring circuit 30X calculates the product of the number N and the allowable current of one secondary battery cell 111 to calculate the supply current I2 that can be supplied to the load by the battery unit 1X. When the supply current I2 is smaller than the current that needs to be supplied to the load, the voltage monitoring circuit 30X turns the switch 20 off. Thus, the battery unit 1X stops the supply of power to the load.

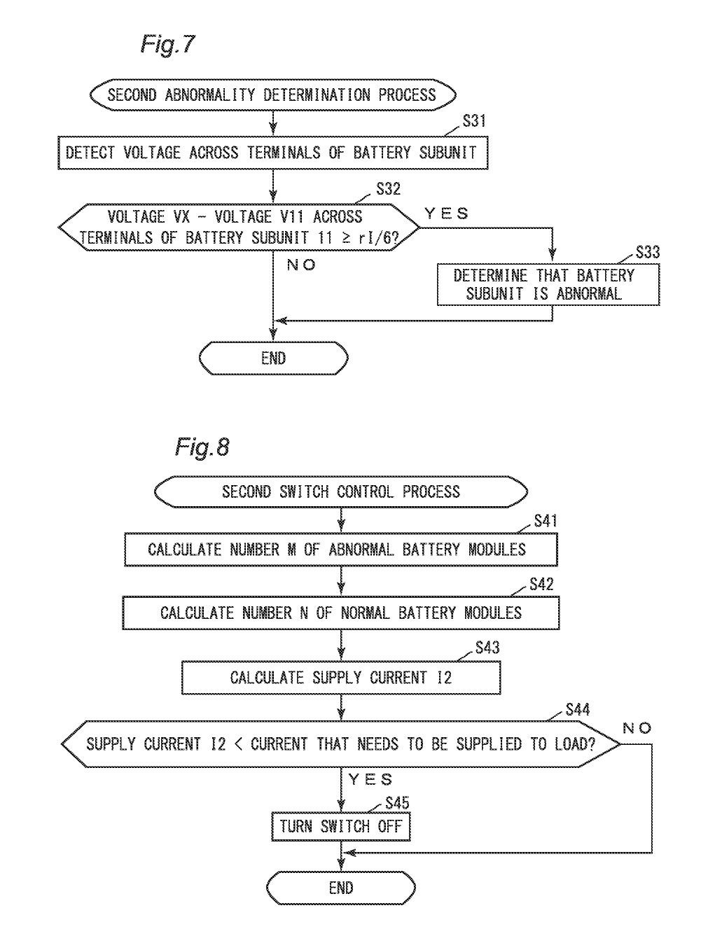

Next, operations of the battery unit 1X of the second embodiment will be described with reference to FIGS. 7 and 8. A second abnormality determination process will be described with reference to FIG. 7. The second abnormality determination process is performed at regular time intervals.

Upon starting the second abnormality determination process, the voltage V11 across the terminals of the battery subunit 11 is detected (step S31). Specifically, the voltage detector 311 detects the voltage V11 and outputs the detected voltage V11 to the voltage monitoring circuit 30X.

After step S31, the voltage monitoring circuit 30X determines whether the difference between the voltage VX across the terminals of the battery subunit 11 experienced when the battery subunit 11 is normal and the voltage V11 received from the voltage detector 311 is rI/6 or larger (step S32). In the present implementation, the threshold is preset to rI/6 for the reasons similar to those for step S14 of the first abnormality determination process (FIG. 3).

If the difference between the voltage VX and the value of the voltage V11 received from the voltage detector 311 is rI/6 or larger (YES at step S32), the voltage monitoring circuit 30X determines that there is an abnormality in the battery subunit 11 is abnormal (step S33). Thus, the second abnormality determination process ends.

If the difference between the voltage VX and the value of the voltage V11 received from the voltage detector 311 is smaller than rI/6 (NO at step S32), the second abnormality determination process ends.

By performing the second abnormality determination process described above, the voltage monitoring circuit 30X is capable of determining whether the battery subunit 11 is abnormal based on the voltage V11 across the terminals of the battery subunit 11.

Next, a second switch control process will be described with reference to FIG. 8. The second switch control process is performed if the voltage monitoring circuit 30X has determined that the battery subunit 11 is abnormal.

First, the number M of the battery modules 110 with abnormalities is calculated (step S41). Specifically, the voltage monitoring circuit 30X calculates the number M of the battery modules 110 with abnormalities based on the difference VX−V11 between the voltage VX and the voltage V11 across the terminals of the battery subunit 11, in a manner similar to that for step S22 of the first switch control process (FIG. 4).

After step S41, the number N of the normal battery modules 110 out of the battery modules 110 included in the battery subunit 11 is determined (step S42). Specifically, the voltage monitoring circuit 30X calculates the number N of the normal battery modules 110 out of the battery modules 110 included in the battery subunit 11 in a manner similar to that for step S23 of the first switch control process (FIG. 4).

After step S42, the supply current I2 is calculated (step S43). Specifically, the voltage monitoring circuit 30X calculates the supply current I2 by calculating the product of the number N of the normal battery modules 110 and the current value of the allowable current of one secondary battery cell 111. That is, the supply current I2 is a current that can be supplied to the load by the battery unit 1.

After step S43, it is determined whether the supply current I2 is smaller than the current that needs to be supplied to the load (step S44).

If the supply current I2 is smaller than the current that needs to be supplied to the load (YES at step S44), the switch is turned off (step S45). Thus, the battery unit 1X stops the power supply to the load. Upon performing step S45, the second switch control process ends.

If the supply current I2 is not smaller than the current that needs to be supplied to the load (NO at step S44), the second switch control process ends, with the switch 20 remaining on.

By performing the second switch control process described above, the battery monitoring circuit 30X does not turn the switch 20 off even when the battery subunit 11 is abnormal if the battery subunit 11 is capable of supplying the current that needs to be supplied to the load. That is, the battery unit 1X is capable of continuing to supply power to the load.

Otherwise, the second embodiment can be described similarly to the first embodiment.

### Variations of Second Embodiment

In the second embodiment, the battery module 110 includes one secondary battery cell 111, however, the embodiment is not limited to such a configuration. For example, the battery module 110 may include a plurality of secondary battery cells 111 connected in series.

In the above description, the switch 20 is connected between the positive electrode terminal of the battery subunit 11 and the load, however, the embodiment is not limited to such a configuration. The switch 20 may be connected between the negative electrode terminal of the battery subunit 11 and the load.

### Third Embodiment

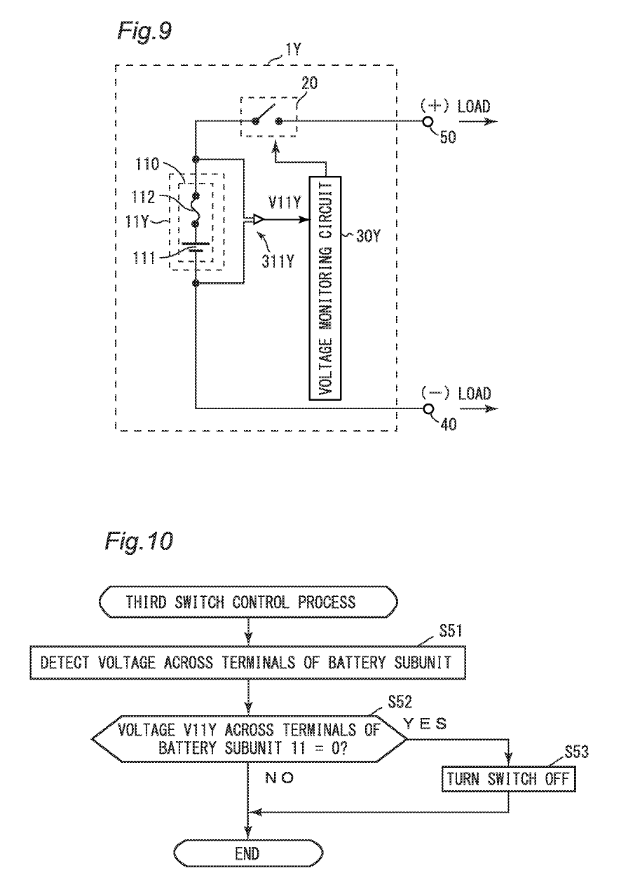

Next, referring to FIGS. 9 and 10, a battery unit 1Y of a third embodiment will be described. FIG. 9 is a circuit diagram showing the circuit structure of the battery unit 1Y of the third embodiment.

The battery unit 1Y of the third embodiment is similar to the battery unit 1 except for replacing the battery subunit 11 of the battery unit 1 shown in FIG. 1 by a battery subunit 11Y, replacing the voltage monitoring circuit 30 by a voltage monitoring circuit 30Y, replacing the voltage detector 311 by a voltage detector 311Y and eliminating the battery subunits 12 and 13 and voltage detectors 321 and 331.

The battery subunit 11Y of the third embodiment includes one battery module 110 of FIG. 1. The battery subunit 11Y is connected between the plus terminal 40 and the minus terminal 50.

The voltage detector 311Y is connected to both terminals of the battery subunit 11Y. The voltage detector 311Y detects the voltage V11Y across the terminals of the battery subunit 11Y and outputs the detected voltage V11Y to the voltage monitoring circuit 30Y.

The voltage monitoring circuit 30Y monitors the voltage V11Y across the terminals of the battery subunit 11Y. Specifically, the voltage monitoring circuit 30Y receives the voltage V11Y from the voltage detector 311Y.

If the voltage V11Y received from the voltage detector 311Y is zero, the voltage monitoring circuit 30Y determines that the battery subunit 11Y is abnormal. If the voltage monitoring circuit 30Y determines that the battery subunit 11Y is abnormal, it turns the switch 20 off. Thus, the battery unit 1Y stops the supply of power to the load.

Next, operations of the battery unit 1Y of the third embodiment will be described with reference to FIG. 10. A third switch control process is performed at regular time intervals.

Upon starting the third switch control process, the voltage V11Y across the terminals of the battery subunit 11Y is detected (step S51). Specifically, the voltage detector 311Y detects the voltage V11Y and outputs the detected voltage V11Y to the voltage monitoring circuit 30Y.

After step S51, the voltage monitoring circuit 30Y determines whether the voltage V11Y received from the voltage detector 311Y is zero (step S52).

If the voltage V11Y received from the voltage detector 311Y is zero (YES at step S52), the voltage monitoring circuit 30Y determines that the fuse 112 has blown, and turns the switch 20 off (step S53). Thus, the battery unit 1Y stops the supply of power to the load. Upon performing step S53, the third switch control process ends.

If the voltage V11Y received from the voltage detector 311Y is not zero (NO at step S52), the voltage monitoring circuit 30Y determines that the fuse 112 has not blown, and the third switch control process ends.

By performing the third switch control process described above, the voltage monitoring circuit 30Y determines whether the battery subunit 11Y is abnormal based on the voltage V11Y across the terminals of the battery subunit 11Y.

Otherwise, the third embodiment can be described similarly to the first embodiment.

### Variations of Third Embodiment

In the third embodiment, the battery module 110 includes one secondary battery cell 111, however, the embodiment is not limited to such a configuration. For example, the battery module 110 may include a plurality of secondary battery cells 111 connected in series.

In the above description, the switch 20 is connected between the positive electrode terminal of the battery subunit 11Y and the load, however, the embodiment is not limited to such a configuration. The switch 20 may be connected between the negative electrode terminal of the battery subunit 11Y and the load.

In the above description, if the voltage V11Y received from the voltage detector 311Y is zero, the voltage monitoring circuit 30Y turns the switch 20 off (step S53), however, the embodiment is not limited to such a configuration. Step S53 of the third switch control process (FIG. 10) may be eliminated. This is because the battery unit 1Y is not able to supply power to the load once the fuse 112 has blown.

It should be understood that the embodiments disclosed herein are exemplary only in every respect and not limitative. It is contemplated that the scope of the present invention is not defined by the above description of the embodiments but by the claims, and includes all the modifications within the spirit and scope equivalent to those of the claims.

### INDUSTRIAL APPLICABILITY

The present invention is applicable to a battery unit.

1. A battery unit comprising:
a battery subunit including a battery module having a secondary battery cell and a fuse connected in series;
a voltage monitoring circuit monitoring a voltage across terminals of the battery subunit; and
a switch connected between the battery subunit and a load,
wherein, the battery subunit includes one battery module or a plurality of battery modules connected in parallel, and
if the battery subunit includes one battery module, the voltage monitoring circuit turns the switch off when it determines that the fuse in the battery module blew, and, if the battery subunit includes a plurality of battery modules, turns the switch off depending on the voltage when the battery subunit is incapable of providing a current that needs to be supplied to the load.

2. A battery unit comprising:
a battery subunit including a battery module having a secondary battery cell and a fuse connected in series;
a voltage monitoring circuit monitoring a voltage across terminals of the battery subunit; and
a switch connected between the battery subunit and a load,
wherein, the battery subunit includes one battery module or a plurality of battery modules connected in parallel,
a plurality of battery subunits are connected in series, and
the voltage monitoring circuit monitors the voltage across the terminals of each of the plurality of battery subunits, and, if each of the plurality of battery subunits includes one battery module, the voltage monitoring circuit turns the switch off when it determines that the fuse in the battery module blew, and, if each of the plurality of battery subunits includes a plurality of battery modules, turns the switch off depending on the voltages when one of the plurality of battery subunits is incapable of providing a current that needs to be supplied to the load.

3. A battery unit comprising:
a battery subunit including a battery module having a secondary battery cell and a fuse connected in series;
a voltage monitoring circuit monitoring a voltage across terminals of the battery subunit; and
a switch connected between the battery subunit and a load,
wherein, the battery subunit includes one battery module or a plurality of battery modules connected in parallel, and
if the battery subunit includes one battery module, the voltage monitoring circuit turns the switch off when it determines that the fuse in the battery module blew, and, if the battery subunit includes a plurality of battery modules, turns the switch off depending on the voltage when a current flowing through one normal battery module exceeds an allowable current of the secondary battery cells.

4. A battery unit comprising:
a battery subunit including a battery module having a secondary battery cell and a fuse connected in series;
a voltage monitoring circuit monitoring a voltage across terminals of the battery subunit; and
a switch connected between the battery subunit and a load,
wherein, the battery subunit includes one battery module or a plurality of battery modules connected in parallel,
a plurality of battery subunits are connected in series, and
the voltage monitoring circuit monitors the voltage across the terminals of each of the plurality of battery subunits, and, if each of the plurality of battery subunits includes one battery module, the voltage monitoring circuit turns the switch off when it determines that the fuse in the battery module blew, and, if each of the plurality of battery subunits includes a plurality of battery modules, turns the switch off depending on the voltages when a current flowing through one normal battery module exceeds an allowable current of the secondary battery cells.

5. The battery unit according to claim 3 or 4, wherein
if each of the plurality of battery subunits includes a plurality of battery modules, the voltage monitoring circuit calculates the current by calculating a number of normal battery modules based on the voltage and dividing a current that needs to be supplied to the load by the number.
